(19) United States
(12) Patent Application Publication
(10) Pub. No.: US 2019/0113697 A1
(43) Pub. Date: Apr. 18, 2019

(54) DEMOUNTABLE OPTICAL CONNECTOR FOR OPTOELECTRONIC DEVICES

(71) Applicant: NANOPRECISION PRODUCTS, INC., El Segundo, CA (US)

(72) Inventors: Shuhe LI, Pasadena, CA (US); Robert Ryan VALLANCE, Newbury Park, CA (US)

(21) Appl. No.: 15/943,502

(22) Filed: Apr. 2, 2018

Related U.S. Application Data
(63) Continuation of application No. 14/714,240, filed on May 15, 2015, now abandoned.
(60) Provisional application No. 61/994,097, filed on May 15, 2014.

(51) Int. Cl. G02B 6/42; G02B 6/30

(52) U.S. Cl. CPC G02B 6/4231; G02B 6/30; G02B 6/4249; G02B 6/4214; G02B 6/423; G02B 6/4292

(57) ABSTRACT

A reconnectable connection between an optical bench supporting an optical fiber and a photonic integrated circuit (PIC), which a foundation and a connector that is configured and structured to be removably attachable for reconnection to the foundation in alignment therewith. The foundation can be aligned to electro-optical elements in the PIC. The foundation may be permanently attached with respect to the opto-electronic device. The optical bench can be removably attached to the foundation. Alignment between the foundation and the connector is achieved by kinematic coupling, quasi-kinematic coupling, or elastic-averaging coupling.

### PRIORITY CLAIM

This application is a continuation of U.S. patent application Ser. No. 14/714,240 filed on May 15, 2015, which claims the priority of U.S. Provisional Patent Application No. 61/994,097 filed on May 15, 2014. This application is fully incorporated by reference as if fully set forth herein. All publications noted below are fully incorporated by reference as if fully set forth herein.

### BACKGROUND OF THE INVENTION

### 1. Field of the Invention

The present invention relates to coupling of light into and out of optoelectronic devices (e.g., photonic integrated circuits (PICs)), and more particular to the optical connection of optical fibers to PICs.

### 2. Description of Related Art

Photonic integrated circuits integrate multiple electro-optical devices such as lasers, photodiodes, modulators, and waveguides into a single chip. It is necessary for these PICs to have optical connections to other PICs, often in the form an organized network of optical signal communication. The connection distances may range from a several millimeters in the case of chip-to-chip communications up to many kilometers in case of long-reach applications. Optical fibers can provide an effective connection method since the light can flow within the optical fibers at very high data rates (>25 Gbps) over long distances due to low-loss optical fibers.

One of the most expensive components within photonic networks are the fiber-optic connectors. For proper operation, a PIC typically needs to efficiently couple light between an external optical fiber and one or more of on-chip waveguides. Most PICs require single-mode optical connections that require stringent alignment tolerances between optical fibers and the PIC, typically less than 1 micrometer. This is challenging and so much optical fibers are aligned to elements on the PICs using an active alignment approach in which the position and orientation of the optical fiber(s) is adjusted by machinery until the amount of light transferred between the fiber and PIC is maximized. This is a time consuming process that is generally done after the PIC is diced from the wafer and mounted within a package. This postpones the fiber-optic connection to the end of the production process. Once the connection is made, it is permanent, and would not be demountable, separable or detachable without likely destroy the integrity of connection for any hope of remounting the optical fiber to the PIC. In other words, optical fiber is not removably attachable to the PIC, and the fiber connection, and separation would be destructive and not reversible (i.e., not reconnectable).

It would be advantageous if the fiber-optic connections could be created prior to dicing the discrete PICs from the wafer; this is often referred to as wafer-level attachment. Manufacturers of integrated circuits and PICs often have expensive capital equipment capable of sub-micron alignment (e.g. wafer probers and handlers for testing integrated circuits), whereas companies that package chips generally have less capable machinery (typically several micron alignment tolerances which is not adequate for single-mode devices) and often use manual operations. However, it is impractical to permanently attach optical fibers to PICs prior to dicing since the optical fibers would become tangled, would be in the way during the dicing operations and packaging procedures, and are practically impossible to manage when the PICs are pick-and-placed onto printed circuit boards and then soldered to the PCBs at high temperatures.

The current state-of-the-art attempts to achieve stringent alignment tolerances using polymer connector components, but polymers have several fundamental disadvantages. First, they are elastically compliant so that they deform easily under external applied loads. Second, they are not dimensionally stable and can change size and shape especially when subjected to elevated temperatures such as those found in computing and networking hardware. Third, the coefficient of thermal expansion (CTE) of polymers is much larger than the CTE of materials that are commonly used in PICs. Therefore, temperature cycles cause misalignment between the optical fibers and the devices on the PIC. In some cases, the polymers cannot withstand the processing temperatures used while soldering PICs onto printed circuit boards.

What is needed is an improved approach to optically couple input/output of optical fibers to PICs, which improves tolerance, manufacturability, ease of use, functionality and reliability at reduced costs.

### SUMMARY OF THE INVENTION

The present invention overcomes the drawbacks of the prior art by providing a demountable/separable and reconnectable connection between an optical bench (e.g., supporting an optical fiber) and an opto-electronic device (e.g., grating coupler of a photonic integrated circuits (PIC)). The novel connection includes a foundation and a connector that is configured and structured to be removably attachable for reconnection to the foundation in alignment therewith. The foundation may be an integral part of the opto-electronic device (e.g., part of a PIC packaging), or a separate component attached to the opto-electronic device.

In accordance with one embodiment of the present invention, the foundation is initially attached to a support (e.g., housing) of the opto-electronic device (e.g., PIC). This foundation can be aligned to electro-optical elements in the device. The foundation may be permanently attached with respect to the opto-electronic device. The optical bench (e.g., supporting an optical fiber) can be removably attached to the foundation, via a ‘separable’ or ‘demountable’ or ‘detachable’ action that accurately optically aligns the optical components/elements in the optical bench to the opto-electronic device along a desired optical path. In accordance with the present invention, a detachable connector supports or is part of the optical bench. In order to maintain optical alignment for each connect and disconnect and reconnect, this connector needs to be precisely and accurately aligned to the foundation. In one embodiment of the present invention, the connector and foundation are aligned with one another using a passive mechanical alignment constructed from geometric features on the two bodies.

In a further embodiment, the present invention provides a structure and method for this passive alignment using kinematic coupling, quasi-kinematic coupling, or elastic-averaging couplings. One approach is a kinematic coupling with six points of contact between the connector and the foundation. Six points is the minimum necessary for rigid body static equilibrium and consequently provides a deterministic and repeatable alignment between the bodies. An alternate approach that provides additional stiffness at the interface and reduces the dependence on the bending stiffness of the connector is to use a quasi-kinematic approach which adds additional contact points or replaces a contact point with a contact line. Additional contact points and contact lines increases the stiffness of the interface with modest reductions in the repeatability. In this embodiment, the contact is spread over larger area between the two bodies and stiffens the bending modes of the connector. A third embodiment maximizes the stiffness of the interface using many, perhaps hundreds or thousands, of contact points or small surfaces (e.g. tetrahedral) that are spread over as much area as possible. This requires accurate location of the mating surfaces and more stringent tolerances on the shape and size of the surfaces. However, this can be accomplished with ultra-high precision stamping.

In another aspect of the present invention, the passive alignment features on the foundation and connector can be integrally/simultaneous formed by precision stamping, which allows the components to be produced economically in high or small volumes, while improving tolerance, manufacturability, ease of use, functionality and reliability. Further, either or both of the foundation and the connector (e.g., a micro optical bench (MOB)) can be precisely formed by high-precision stamping. The foundation and/or optical bench components should be made of a stampable materials like ductile metals such as Kovar, Invar, stainless steel, aluminum. The optical bench and foundation should both have similar coefficients of thermal expansion (CTEs), so that misalignment does not occur during temperature cycles and stress/strains are not generated.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIGS. 1A and 1B illustrate an optical connector in accordance with one embodiment of the present invention.

FIGS. 2A to 2D illustrate coupling of the optical connector to a foundation on an opto-electronic device.

FIGS. 3A to 3C illustrate various embodiments of passive alignment couplings.

FIGS. 4A to 4G illustrate an alternate embodiment of passive alignment coupling of a connector directly to the package of the opto-electronic device.

### DETAILED DESCRIPTION OF THE PREFERRED EMBODIMENTS

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

The present invention provides a novel approach to coupling light between an optical bench (e.g., supporting an optical fiber) and an opto-electronic device (e.g., grating coupler of a photonic integrated circuits (PIC)). The novel connection includes a foundation and a connector that is configured and structured to be removably attachable for reconnection to the foundation in alignment therewith.

The concept of the present invention will be discussed with reference to an example of a PIC as an opto-electronic device, and an optical bench as an optical coupling device (connector) for use to optically coupling an input/output end of an optical component (e.g., an optical fiber) supported in the optical bench with the opto-electronic device. The present invention may be applied to provide removable/reconnectable form structures and parts used in other fields.

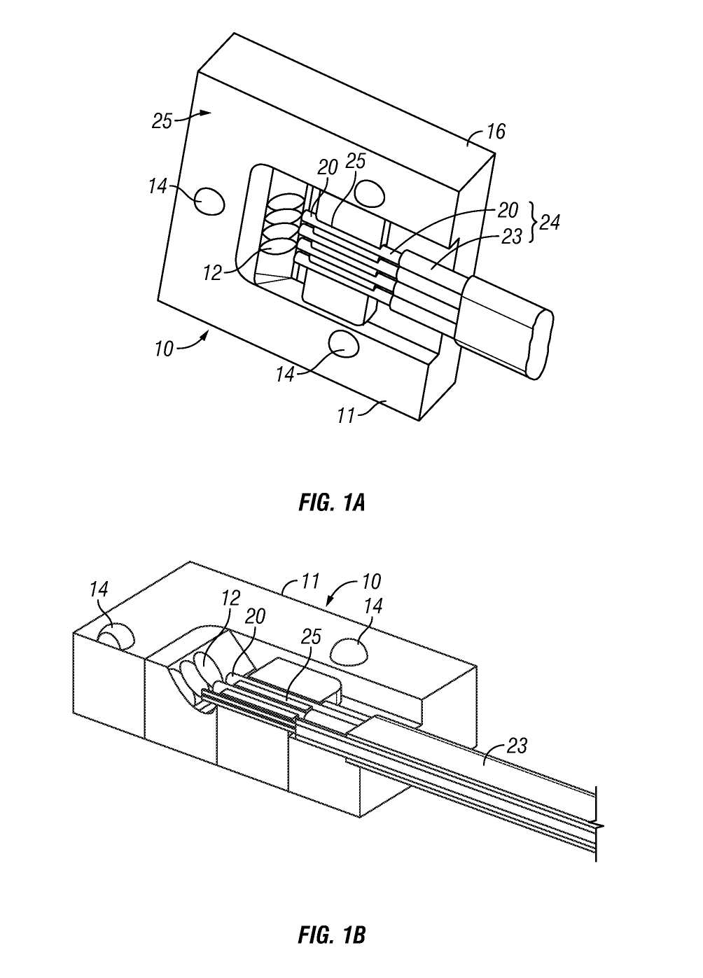

FIGS. 1A-1B illustrate an optical coupling device in the form of an optical connector 10, incorporating a micro optical bench 11 for use in connection with an optical component in the form of optical fibers. The optical fiber cable 22 has four optical fibers 20 protected by protective buffer and jacket layers 23. The connector 10 includes a base 16, which defines structured features including an alignment structure comprising open grooves 25 for retaining bare sections of optical fibers 20 (having cladding exposed, without protective buffer and jacket layers 23), and structured reflective surfaces 12 (i.e., four reflectors) having a plane inclined at an angle relative to the greater plane of the base 16. Each structured reflective surface 12 may have a flat, concave or convex surface profile and/or possess optical characteristics corresponding to at least one of the following equivalent optical element: mirror, focusing lens, diverging lens, diffraction grating, or a combination of the foregoing. The structure reflective surface 12 may have a compound profile defining more than one region corresponding to a different equivalent optical element (e.g., a central region that is focusing surrounded by an annular region that is diverging). In one embodiment, the structure reflective surfaces 12 may have a concave aspherical reflective surface profile, which serves both functions of reflecting and reshaping (e.g., collimating or focusing) a diverging incident light, without requiring a lens. Accordingly, each structured reflective surface 12 functions as an optical element that directs light to/from an external optical component (in this case an opto-electronic component, such as a photonic integrated circuit (PIC) 2, by reflection from/to the output/input end 21 of the optical fiber 20, along a defined optical path 100 (schematically shown in FIG. 1C) that is aligned to the optical axis of the various optical components and elements (i.e., optical fibers 20, structured reflective surfaces 12, and PIC 2).

The open grooves 25 are sized to receive and located to precisely position the end section of the optical fibers 20 in alignment with respect to the structured reflective surfaces 12 along the optical path 100. The end face 21 (input/output end) of each optical fibers 20 is maintained at a pre-defined distance with respect to a corresponding structured reflective surface 12.

In a further aspect of the present invention, the mirror/structured reflective surface and optical fiber alignment structure in the optical connector can be integrally/simultaneous formed by precision stamping of a stock material (e.g., a metal blank or strip), which allows the connector components to be produced economically in high or small volumes, while improving tolerance, manufacturability, ease of use, functionality and reliability. By forming the structure reflective surface, the passive alignment features (discussed below) and the optical fiber alignment structure simultaneously in a same, single final stamping operation, dimensional relationship of all features requiring alignment on the same work piece/part can be maintained in the final stamping step. Instead of a punching operation with a single strike of the punch to form all the features on the optical bench, it is conceivable that multiple strikes may be implemented to progressive pre-form certain features on the optical bench, with a final strike to simultaneously define the final dimensions, geometries and/or finishes of the various structured features on the optical bench, including the mirror, optical fiber alignment structure/groove, passive alignment features discussed below, etc. that are required to ensure (or play significant role in ensuring) proper alignment of the respective components/structures along the design optical path.

The Assignee of the present invention, nanoPrecision Products, Inc., developed various proprietary optical coupling/connection devices having optical benches used in connection with optical data transmission. The present invention is more specifically directed to detachably/reconnectably coupling optical fibers to grating couplers in PICs, while adopting similar concept of stamping optical benches including stamped mirrors practiced in the earlier optical coupling devices.

For example, US2013/0322818A1 discloses an optical coupling device having a stamped structured surface for routing optical data signals, in particular an optical coupling device for routing optical signals, including a base; a structured surface defined on the base, wherein the structured surface has a surface profile that reshapes and/or reflect an incident light; and an alignment structure defined on the base, configured with a surface feature to facilitate positioning an optical component on the base in optical alignment with the structured surface to allow light to be transmitted along a defined path between the structured surface and the optical component, wherein the structured surface and the alignment structure are integrally defined on the base by stamping a malleable material of the base.

US2013/0294732A1 further discloses a hermetic optical fiber alignment assembly having an integrated optical element, in particular a hermetic optical fiber alignment assembly including a ferrule portion having a plurality of grooves receiving the end sections of optical fibers, wherein the grooves define the location and orientation of the end sections with respect to the ferrule portion. The assembly includes an integrated optical element for coupling the input/output of an optical fiber to optoelectronic devices in an optoelectronic module. The optical element can be in the form of a structured reflective surface. The end of the optical fiber is at a defined distance to and aligned with the structured reflective surface. The structured reflective surfaces and the fiber alignment grooves can be formed by stamping.

U.S. patent application Ser. No. 14/695,008 further discloses an optical coupling device for routing optical signals for use in an optical communications module, in particular an optical coupling device in which defined on a base are a structured surface having a surface profile that reshapes and/or reflect an incident light, and an alignment structure defined on the base, configured with a surface feature to facilitate positioning an optical component on the base in optical alignment with the structured surface to allow light to be transmitted along a defined path between the structured surface and the optical component. The structured surface and the alignment structure are integrally defined on the base by stamping a malleable material of the base. The alignment structure facilitates passive alignment of the optical component on the base in optical alignment with the structured surface to allow light to be transmitted along a defined path between the structured surface and the optical component. The structured surface has a reflective surface profile, which reflects and/or reshape incident light.

U.S. Pat. No. 7,343,770 discloses a novel precision stamping system for manufacturing small tolerance parts. Such inventive stamping system can be implemented in various stamping processes to produce the devices disclosed in above-noted nanoPrecision patent documents, and can similarly be implemented to produce the structures disclosed herein (including the structures for the optical bench 11 discussed above, as well as the structure of the foundation 1 discussed below. These stamping processes involve stamping a bulk material (e.g., a metal blank or stock), to form the final surface features at tight (i.e., small) tolerances, including the reflective surfaces having a desired geometry in precise alignment with the other defined surface features.

Essentially, for the optical connector 10, the base 16 defines an optical bench 11 for aligning the optical fibers 20 with respect to the structured reflective surfaces 12. By including the grooves 25 on the same, single structure that also defines the structured reflective surfaces 12, the alignment of the end sections 21 of the optical fibers 20 to the structured reflective surfaces 12 can be more precisely achieved with relatively smaller tolerances by a single final stamping to simultaneous define the final structure on a single part, as compared to trying to achieve similar alignment based on features defined on separate parts or structures. By forming the structure reflective surfaces 12 and the optical fiber alignment structure/grooves 25 simultaneously in a same, single final stamping operation, dimensional relationship of all features/components requiring (or play a role in providing) alignment on the same work piece/part can be maintained in the final stamping step.

The overall functional structures of the optical bench 11 generally resemble the structures of some of the optical bench embodiments disclosed in nanoPrecision's earlier patent documents noted above (i.e., fiber alignment grooves aligned with structured reflective surfaces, and addition features to facilitate proper optical alignment). In the present invention, however, the optical benches are stamped passive alignment features. In the views of FIGS. 1A and 1B, mechanical fiducial or alignment features 14 are formed on the planar surface 15 of the base 16, which facilitates alignment and/or accurate positioning the optical bench 11 with respect to the PIC 2, as will be explained later below.

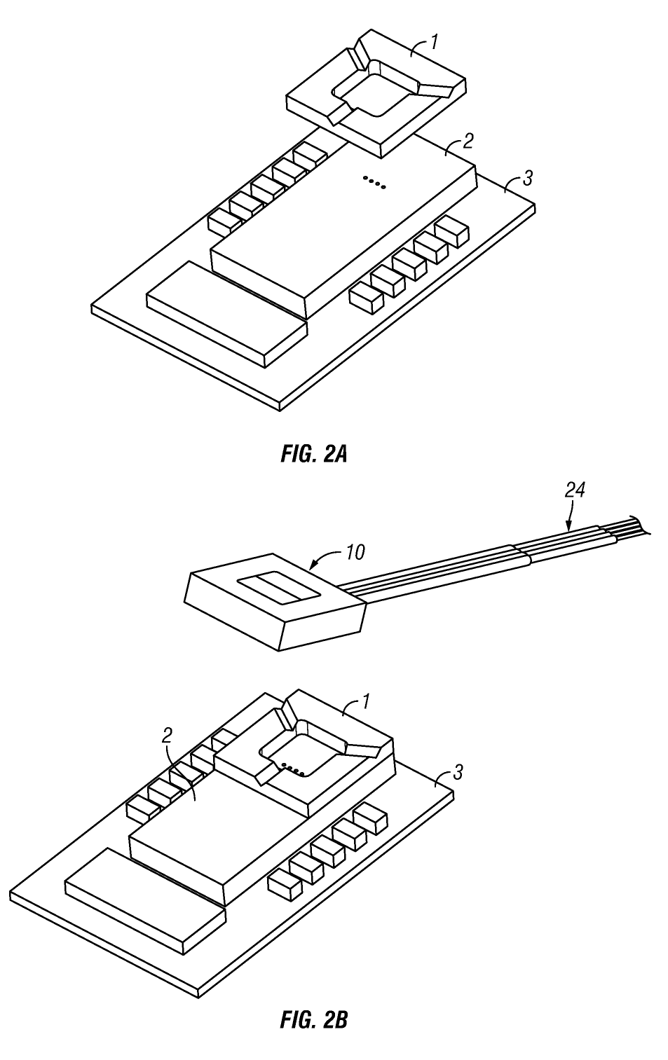

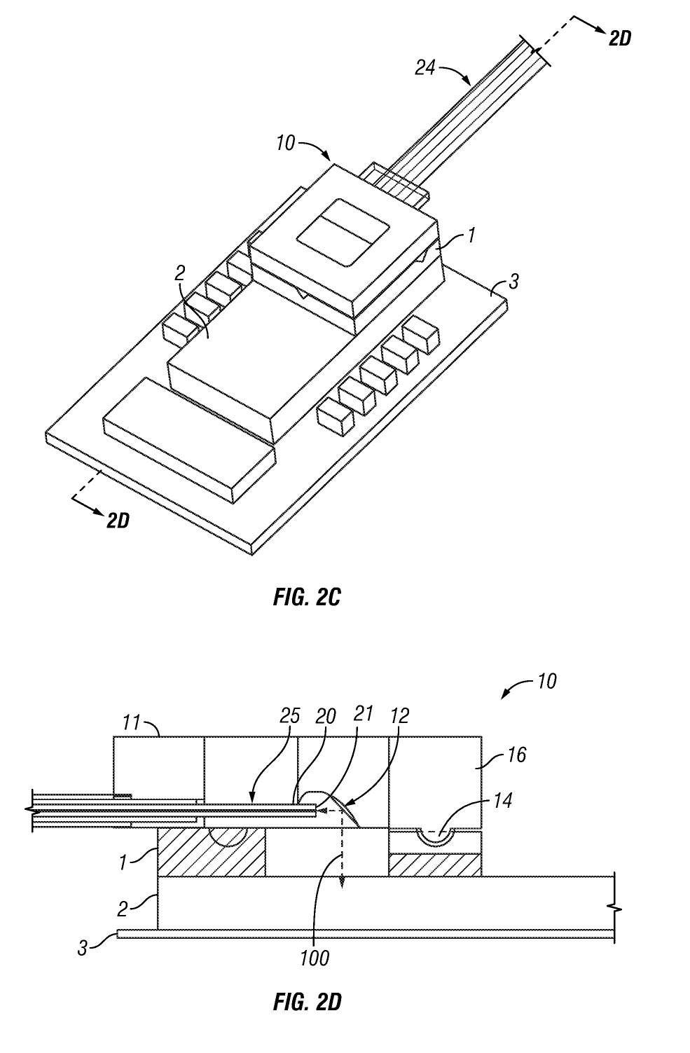

FIGS. 2A to 2D illustrate the presence of a foundation 1 to serve as a connector body to mechanically couple with the optical bench 11 in the optical connector 10, to bring the optical bench 11 in optical alignment with the PIC 2. The foundation 1 is attached to the top surface of PIC 2, at a precise location such that when the connector 10 is connected to the foundation 1, the optical bench 11 would be in optical alignment with the electro-optical components in the underlying PIC 2. Preferably, the foundation 1 is initially attached to the PIC 2 at wafer-level prior to dicing process. The foundation 1 can be aligned to elements on the PIC 2 using precise machinery and then permanently joined to the PIC via epoxy or solder. The foundation 1 remains attached to the PIC 2 during the dicing and packaging processes. The packaged die is then mounted onto the printed circuit board 3 (PCB) using conventional PCB assembly methods (e.g. pick-and-place and wave soldering). This requires that the foundation be able to withstand the elevated temperatures during the soldering operations.

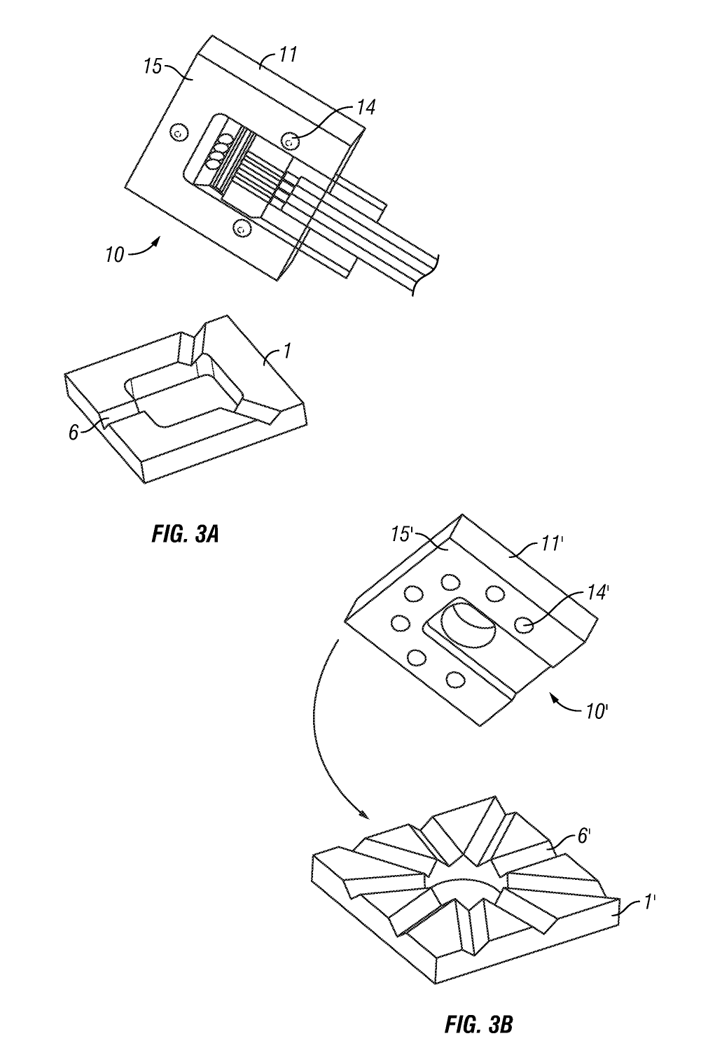

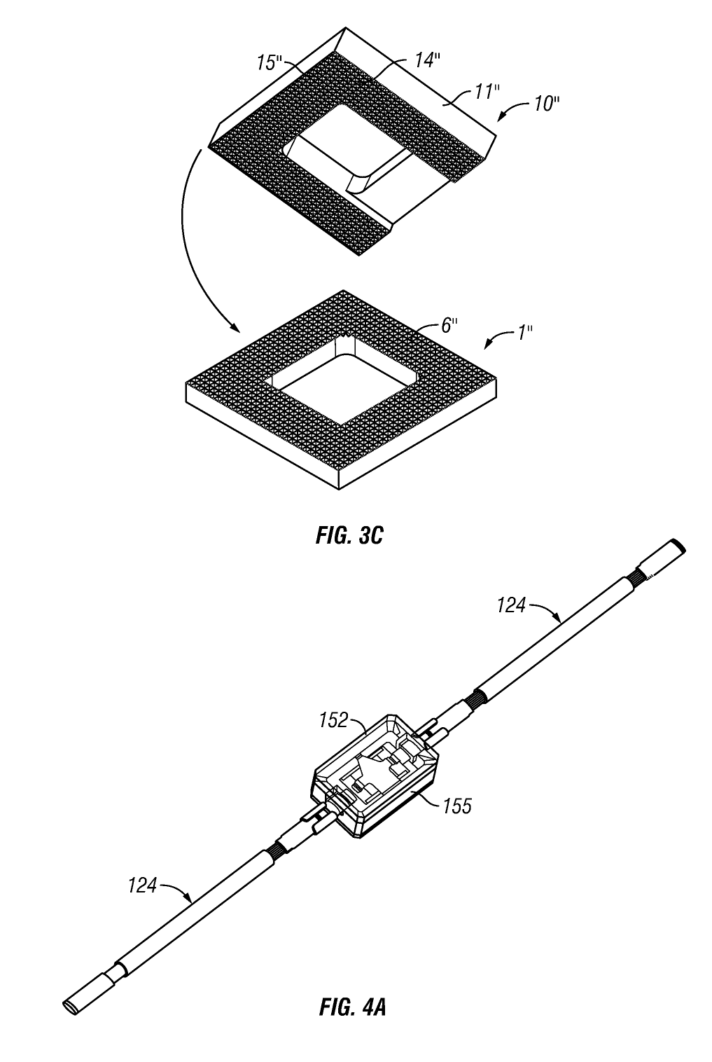

The foundation is provided with grooves, matching/complementing the alignment features 14 under the connector 10. This aspect will be discussed below in connection with the passive alignment approaches in reference to FIGS. 3A to 3C.

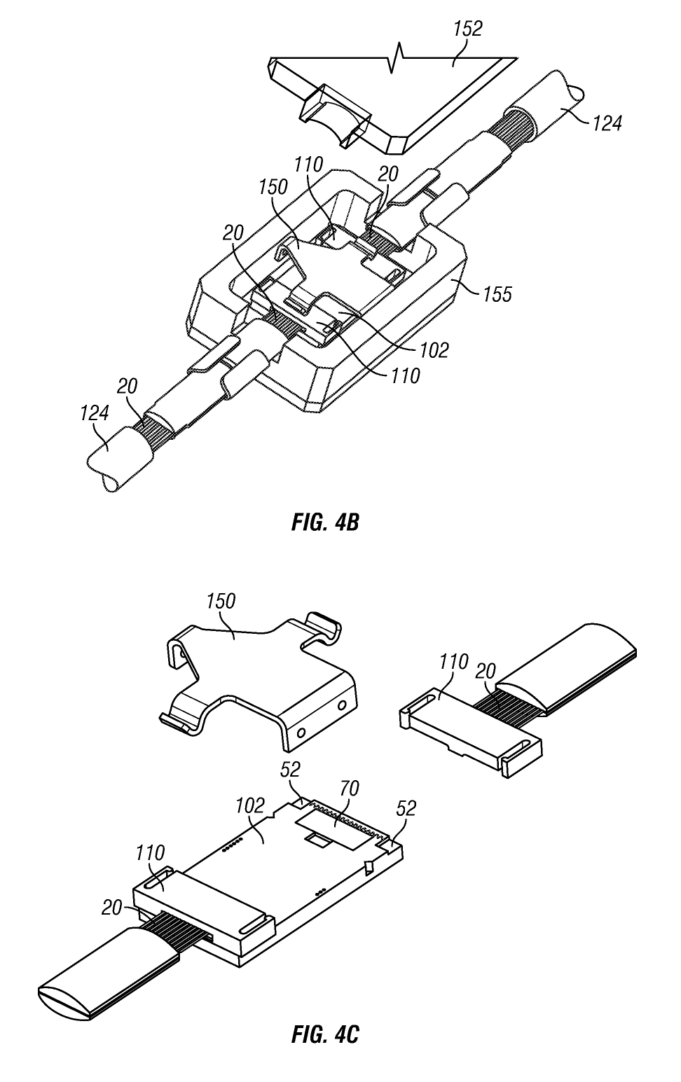

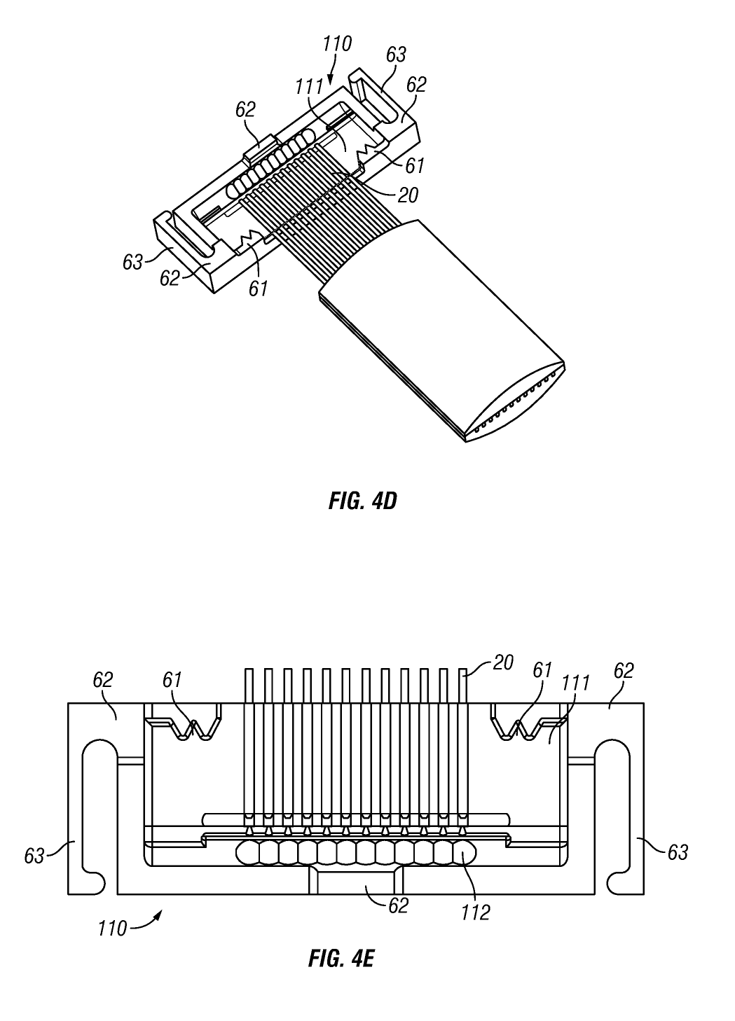

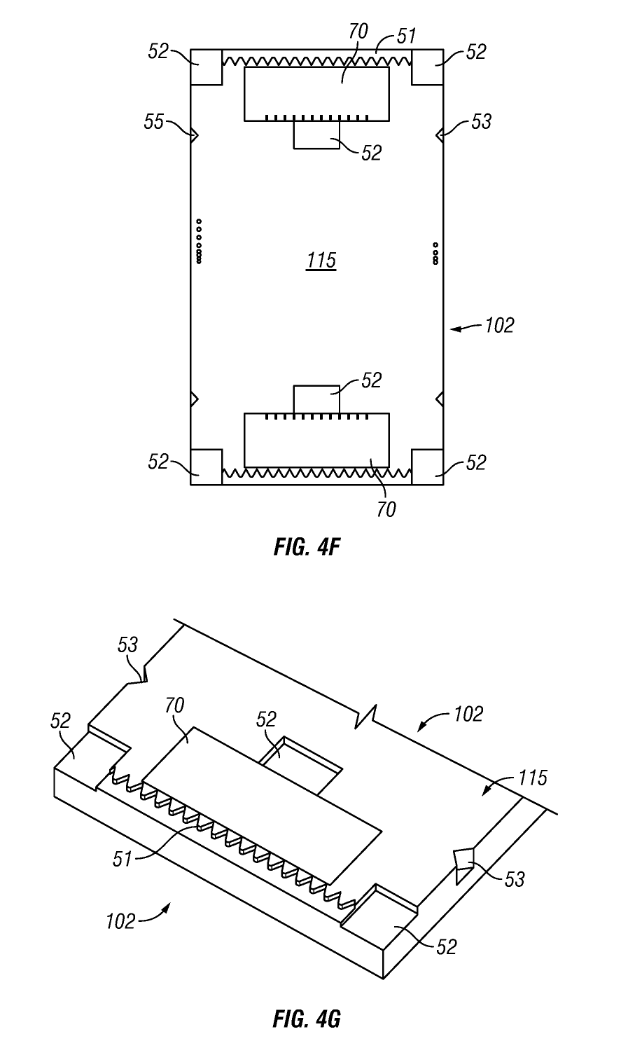

Referring to FIG. 2B, after the PCB 3 is populated (other items not labeled in FIG. 2A), an optical fiber cable 24 supported by the optical connector 10 can be removably attached the foundation 1 or detached from the foundation 1 that is permanently mounted on the PIC 2 via a ‘separable’, ‘demountable’, ‘detachable’, or ‘re-attachable’ action that accurately aligns the ends of the optical fibers with the active electro-optical elements on the PIC 2. FIG. 2D is a sectional illustrating the state of FIG. 2C, in which the connector 10 is attached to the foundation 1 on the PIC 2 that is supported on the PCB 3. The foundation 1 and the optical bench 11 could be maintained in a coupled state by an appropriate biasing device to keep the optical bench 11/connector 10 against the foundation 1. See, for example, the embodiment of FIGS. 4A to 4G.

The invention may use different embodiments for aligning the connector (optical bench) to the foundation. In accordance with the present invention, the connector 10 and foundation 1 are aligned with one another using a passive mechanical alignment constructed from geometric features in the two bodies. This invention provides a structure and method for this alignment using kinematic coupling, quasi-kinematic coupling, or elastic-averaging couplings, each with a different configurations of complementary passive alignment features. FIGS. 3A to 3C illustrates various embodiments of passive alignments adopting various coupling approaches.

FIG. 3A shows the first approach, which is a kinematic coupling with six points of contact between the optical bench 11 and the foundation 1. FIG. 3A is similar to the embodiment shown in FIGS. 1 and 2. There are three semi-circular protrusions 14 on the surface 15, and three complementary grooves 6 (which may having a generally V-shape cross section) on the top surface of the foundation 1. The grooves 6 are in a direction radiating from the center of the foundation 1. Six points is the minimum necessary for rigid body static equilibrium and consequently provides a deterministic and repeatable alignment between the bodies. Since there are only six contact points, there is minimum chance of the alignment being influenced by particles between the mating surfaces of the optical bench 11 and the foundation 1. The disadvantage is that the stiffness of the interface between the two bodies depends on the Hertzian contact at the six points. Furthermore, portions of the optical bench 11 that are not immediately near the contact points are stiffened only by the bending stiffness of the optical bench 11.

FIG. 3B shows an alternate approach that provides additional stiffness at the interface and reduces the dependence on the bending stiffness of the optical bench 11′. This approach uses a quasi-kinematic coupling, which adds additional contact points or replaces a contact point with a contact line. In this embodiment, more semi-circular protrusions are provided on the surface 15′ of the optical bench 11′, and more V-grooves 6′ are provided on the top surface of the foundation 1. Additional contact points and contact lines increases the stiffness of the interface with modest reductions in the repeatability. In this embodiment, the contact is spread over larger area between the two bodies and stiffens the bending modes of the optical bench 11′.

FIG. 3C is a third embodiment, an elastic averaging coupling, which maximizes the stiffness of the interface using many, perhaps hundreds or thousands, of contact points or small surfaces (e.g. tetrahedral) that are spread over as much area as possible. This embodiment requires accurate location of the mating surfaces and more stringent tolerances on the shape and size of the surfaces. However, this can be accomplished with ultra-high precision stamping the top surface of the foundation 1″ with the numerous contact points (e.g., tetrahedral) and the top surface 15″ of the optical bench 11″ with the contact point (e.g., tetrahedral).

Either or both of the foundation and the connector (e.g., an optical bench), including the passive alignment features, can be precisely formed by high-precision stamping. The foundation and/or optical bench components should be made of a stampable materials like ductile metals such as Kovar, Invar, stainless steel, aluminum. If epoxy is used to attach to the foundation to the PIC, then the subsequent process temperatures should not exceed the temperature limit of the epoxy. Solder attachment of the foundation to the optical bench can provide higher process temperatures. The optical bench and foundation should both have similar CTEs so that misalignment does not occur during temperature cycles and stress/strains are not generated.

In accordance with the present invention, stamping is a cost effective means to economically manufacture the geometric features of these couplings in high volumes necessary for commercialization of PICs.

One of the intended commercial use of the invention is in the field of electro-optical transceivers.

FIGS. 4A to 4G illustrate another embodiment of removably/reconnectably coupling an optical bench directly to a foundation that is an integral part of the PIC package (i.e., the package includes surface alignment features, hence functioning similar to a “foundation” in the embodiments discussed above), which involves passive alignment.

FIG. 4A illustrates two jumper optical fiber cables connected to a SiPIC package 102 within a large enclosure 155 with a lid 152. FIG. 4B illustrates the assembled structure of the optical benches/connectors and the SiPIC package within the enclosure 155, with the components held together by a clip. FIG. 4C illustrates one of the connectors 110 separated from the PIC housing. FIGS. 4D and 4E illustrate the connector 110, having an optical bench 111 defined therein. Optical fibers 20 are supported and aligned by the optical bench 111 in the connector 110.

Referring to FIGS. 4F and 4G, the SiPIC package 102 includes area for a grating coupler 70. The alignment features includes a row of teeth 51 adjacent a front edge grating coupler region 70 on the SiPIC package 102, serving X-location alignment. Three stops 52 (depressions) are distributed on the top surface 115 in a triangular fashion, near the lateral and rear edge of the grating coupler region 70, serving Y-location alignment. Two notches 53, on either sides of the SiPIC package 102, serving Z-location alignment. Referring to FIG. 4D and 4E, the complementary alignment features on the connection 110 includes X-location control teeth 61, three Y-location control pads 62, and two Z-location control snaps 63 (e.g., spring clips). The connector 110 can be coupled to the SiPIC package 102 by clipping and snapping the connector 110 onto the region shown in FIG. 4G, in which the control pads 62 would be fit into the stops 52, with the control teeth 61 messed against the teeth 51, and the extended tips of the snaps 63 snapped into place in the notches 53. This forms a removable/reconnectably coupling between the connector 110 and the SiPIC package 102, which relies on passive alignment of the above-described alignment features.

The above described alignment features of the SiPIC package may be formed by silicon etching. The connector 110/optical bench 111 may be formed by stamping, as discussed in the embodiments above.

The optical benches discussed having the structured features for optical alignment can be formed by stamping. By including the passive alignment features (14, 14′ or 14″) discussed above on the same, single structure that also defines the structured reflective surfaces 12 on the optical bench, optical alignment of the end sections 21 of the optical fibers 20 to the PIC 2 and SiPIC 102 can be more precisely achieved with relatively smaller tolerances by a single final stamping to simultaneous define the final structure on a single part, as compared to trying to achieve similar alignment based on features defined on separate parts or structures. By forming the alignment structures simultaneously with rest of the structured features on the optical bench in a same, single final stamping operation, dimensional relationship of all features/components requiring (or play a role in providing) alignment on the same work piece/part can be maintained in the final stamping step.

The passive alignment coupling allows the connector to be detachably coupled to the PIC, via a foundation. The connector can be detached from the foundation and reattached to the foundation without compromising optical alignment.

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

We claim:

1. A connection structure between an optical bench and an opto-electronic device, comprising:
an optical bench having a first body provided with a first set of alignment features;
a foundation provided on the opto-electronic device, having a second body provided with second set of alignment features, wherein the first and second sets of alignment features form a passive alignment coupling, allowing the optical bench to be removably attached to the opto-electronic device.
